(19) United States
(12) Patent Application Publication
(10) Pub. No.: US 2011/0048224 A1
(43) Pub. Date: Mar. 3, 2011

(54) HYDRAULIC PUMP OR HYDRAULIC MOTOR HAVING A ROTATION SPEED SENSOR

(75) Inventors: Scott Dunn, Lawrence, KS (US); Teeyana Wullenschneider, Baldwin City, KS (US); Daniel Jones, Lawrence, KS (US); Soeren Graugaard Laursen, Harlev (DK); Corneliu Iosif Voiculescu, Prahova (RO)

(73) Assignee: SAUER-DANFOSS APS., Nordborg (DK)

(21) Appl. No.: 12/553,127

(22) Filed: Sep. 3, 2009

(51) Int. Cl. F15B 13/00

(52) U.S. Cl. 91/471

(57) ABSTRACT

The invention relates to a hydraulic pump or hydraulic motor having an orbiting cardan shaft. The hydraulic pump or motor includes a housing having an end cover and a port plate. The cardan shaft is mounted in the housing and extends through the port plate. A rotation speed sensor is fixed to the port plate and includes a sensor probe obtaining its signal from the orbiting cardan shaft. A piston may be in contact with the cardan shaft and moving forward and back due to the orbital motion of the cardan shaft. The sensor probe then obtains its signal from the movement of the piston.

### TECHNICAL FIELD

The invention relates to a hydraulic pump or hydraulic motor having an orbiting cardan shaft and, more particularly, to a speed sensor for a hydraulic pump or hydraulic motor having an orbiting cardan shaft.

### BACKGROUND OF THE INVENTION

Many hydraulic pumps and hydraulic motors include speed sensors to detect or monitor rotational speed of the hydraulic pump or hydraulic motor.

One such embodiment of a rotation speed sensor for a hydraulic pump or hydraulic motor is known from US 2006/0257268 A1.

In hydraulic pumps and hydraulic motors for which speed is to be sensed, the rotational speed is tapped off from one of the rotating parts via a sensor. To do so, annular gears or magnet rings are fitted to the rotating parts to produce pulses for the sensor to detect. This means additional complexity in terms of parts, production, assembly and complexity.

Therefore, there is a need for a less complex mechanism for sensing rotational motor speed.

### SUMMARY OF THE INVENTION

The present invention provides a hydraulic pump or a hydraulic motor having improved rotational speed sensing.

The hydraulic pump or hydraulic motor has an orbiting cardan shaft that is mounted in a housing. A piston is in contact with the cardan shaft and moving forward and back. The hydraulic pump or motor includes a rotation speed sensor associated with the piston to detect the rotational speed of the hydraulic pump or hydraulic motor. The rotation speed sensor may be built in to a port plate of the hydraulic pump or hydraulic motor and includes a sensor probe associated with the piston. The sensor probe can also be associated directly with the orbiting cardan shaft.

The sensor probe according to the present invention receives signals directly from the orbiting cardan shaft, eliminating the need for a gear wheel with teeth for impulses for a sensor probe fixed to the housing.

The sensor probe is preferably in the form of a Hall-effect probe of an L-shaped built in part intended for installation in the port plate between the housing and end plate, and a plug element, for electrically connecting the sensor probe to electronics fitted outside the hydraulic motor or hydraulic pump.

Inductive sensor probes, giant magneto resistive (GMR) sensors or anisotropic magneto resistive (AMR) sensors can advantageously be used.

The Hall-effect probe sensor recognizes changes in the magnetic field around the tip of the sensor probe. It contains a seal ring to avoid leaking of hydraulic oil.

One embodiment of the invention is to mount the sensor probe fixedly in the port plate of the hydraulic pump or hydraulic motor and the sensor probe having its signal directly from the orbiting cardan shaft.

Another embodiment is to mount the sensor probe in the port plate of the hydraulic pump or hydraulic motor and in the axial direction of the sensor probe extend with a mechanism of a spring and a piston in touch with the cardan shaft. As the piston follows the movement of the cardan shaft, this movement will take it in and out of the range of the Hall-effect sensor. The spring will apply enough force to maintain constant contact between the piston and cardan shaft. The output of the hall-effect sensor can be calibrated based on the reduction in the gear set and/or gearbox to provide the speed of the machine.

The spring will see e.g. fifty (50) compression cycles for every revolution of the motor output shaft so the spring needs to have a high fatigue limit and also able to apply the correct force.

An advantage compared with the prior art systems with gear wheels for signals is that the present invention provides a simple design with fewer components, meaning a cheaper solution which can be applied to almost any hydraulic motor or hydraulic pump and is ideal for an application in which the output shaft/cardan shaft is inserted into a gearbox and/or mechanism. Because the sensor probe is taking information off of the cardan shaft, which rotates forty-two to forty-eight (42-48) times per shaft revolution, the resolution will be very high.

The solution will not have the same interference as typical systems because the sensor is located clear of the hydraulic housing structure. Further the sensor is not near to the mounting flange, which means easier access for mounting tools e.g. by service.

One further advantage is that the rotation speed sensor can be combined with a temperature sensor, with the result that only one built-in part is required for both measurements.

### BRIEF DESCRIPTION OF THE DRAWINGS

The invention will be more readily understood by reference to the following description, taken with the accompanying drawings, in which:

FIG. 1 is a front view of a hydraulic motor according to an embodiment of the present invention with a cardan shaft in its orbital position closest to a speed sensor;

FIG. 2 is a cross-sectional view of the hydraulic motor of FIG. 1;

FIG. 3 is a front view of the hydraulic motor of FIG. 1 with the cardan shaft in its orbital position most distant from the speed sensor;

FIG. 4 is a cross-sectional view of the hydraulic motor of FIG. 3;

FIG. 5 is a graphical representation showing the motion of the cardan shaft of FIGS. 1-4;

FIG. 6 is a partially exploded front view of another embodiment of the hydraulic motor according to the present invention; and

FIG. 7 is a cross-sectional view of the hydraulic motor of FIG. 6.

### DETAILED DESCRIPTION OF THE PREFERRED EMBODIMENTS

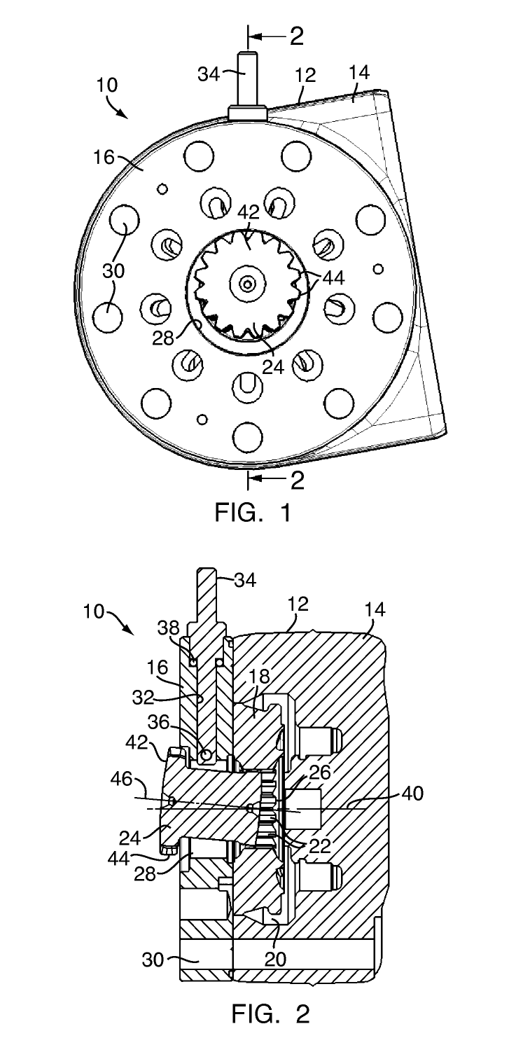

Referring to FIGS. 1 and 2, a hydraulic motor 10 includes a housing 12 having an end cover 14 and a port plate 16 adjacent to one another. The hydraulic motor 10 also includes a disk valve 18 sandwiched between the end cover 14 and the port plate 16 within a cavity 20 formed in the end cover 14. The disk valve 18 includes an inner gear tooth ring (no shown) for interfacing with gear teeth 22. The gear teeth 22 are disposed on an outer diameter of a first end 26 of a cardan shaft 24 and accommodated within the cavity 20. The cardan shaft 24 extends outwardly from the end cover 14 through an opening 28 in the port plate 16. The port plate 16 may also include bores 30, shown in FIG. 1, for hydraulic oil passage. The port plate 16 includes a radial bore 32 that accommodates a rotation sensor 34 having a sensor probe 36 for evaluating the speed of the hydraulic motor 10. The rotation sensor 34 is fixed to the port plate 16 by fastening means, which will depend on the specific type of rotation sensor 34 used. For example, the rotation sensor may be bolted, screwed or press fit into the port plate 16. Additionally, the rotation sensor 34 may include a sealing ring 38 to prevent leakage of hydraulic oil. Preferably, the rotation sensor 34 is a Hall-effect sensor and more preferably is a standard ON/OFF Hall-effect sensor that detects the presence of any metallic material nearby. Suitable Hall-effect sensors are manufactured by Honeywell International Inc. of 101 Columbia Road, Morristown, N.J. Alternatively, the rotation sensor may include inductive sensor probes, giant magneto resistive (GMR) sensors or anisotropic magneto resistive (AMR) sensors.

The disk valve 18 generates rotational movement of the first end 26 of the cardan shaft 24 around a disk center axis 40 of the disk valve 18. A second end 42 of the cardan shaft 24, having gear teeth 44, is in communication with a gear set (not shown) accommodated within a gear housing (not shown) adjacent to the port plate 16. Thus, the port plate 16 is sandwiched between the gear housing (not shown) and the end cover 14. The gear set (not shown) in communication with the second end 42 of the cardan shaft 24 generates an orbital movement of the second end 42 about the disk center axis 40 when the disk valve 18 causes the cardan shaft 24 to rotate. Thus, the disk valve 18 and the gear set (not shown) assure eccentric movement of the valve cardan shaft 24 such that a cardan center axis 46 of the valve cardan shaft 24 moves on a right circular cone path about the disk center axis 40 of the disk valve 18. The orbital movement of the second end 42 of the cardan shaft 24, in connection with the gear set (not shown), causes a motor output shaft (not shown) driven by through the gear set (not shown) to rotate. Through gear reduction, the motor output shaft (not shown) rotates at a lower rotational speed than the rotational speed of the cardan shaft 24. For example, the cardan shaft 24 may rotate forty-two to forty-eight (42-48) times per revolution of the motor output shaft (not shown). Thus, the hydraulic motor 10 is ideal for low speed, high torque applications.

As seen in FIGS. 1 and 2, the cardan shaft 24 is in a top position, such that the cardan shaft 24 is located at its closest proximity to the rotation sensor 34. In this situation, the rotation sensor 34 detects the presence of the cardan shaft 24 and is in an ON state, generating an ON signal.

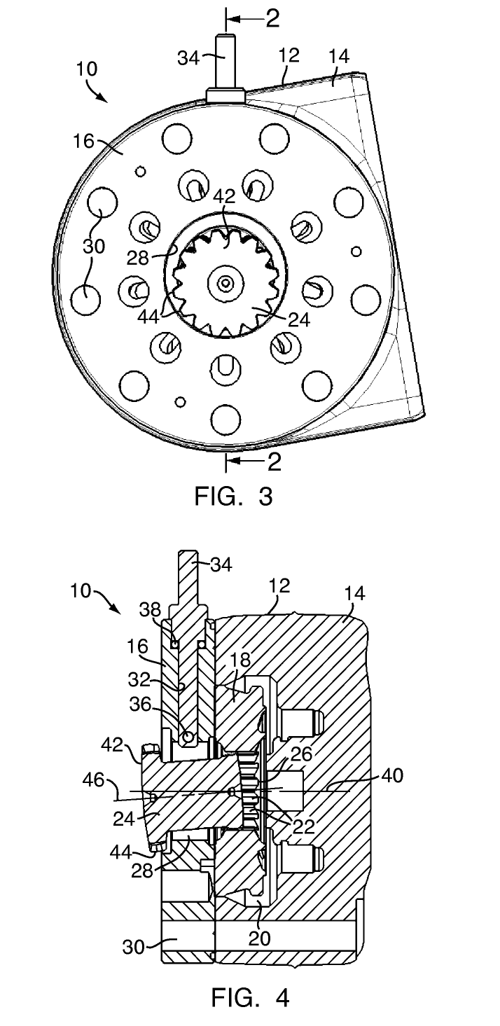

Referring to FIGS. 3 and 4, the cardan shaft 24 is in a bottom position, such that the cardan shaft 24 is located at its farthest proximity to the rotation sensor 34. In this situation, the rotation sensor 34 is in an OFF state and, therefore, not generating an ON signal.

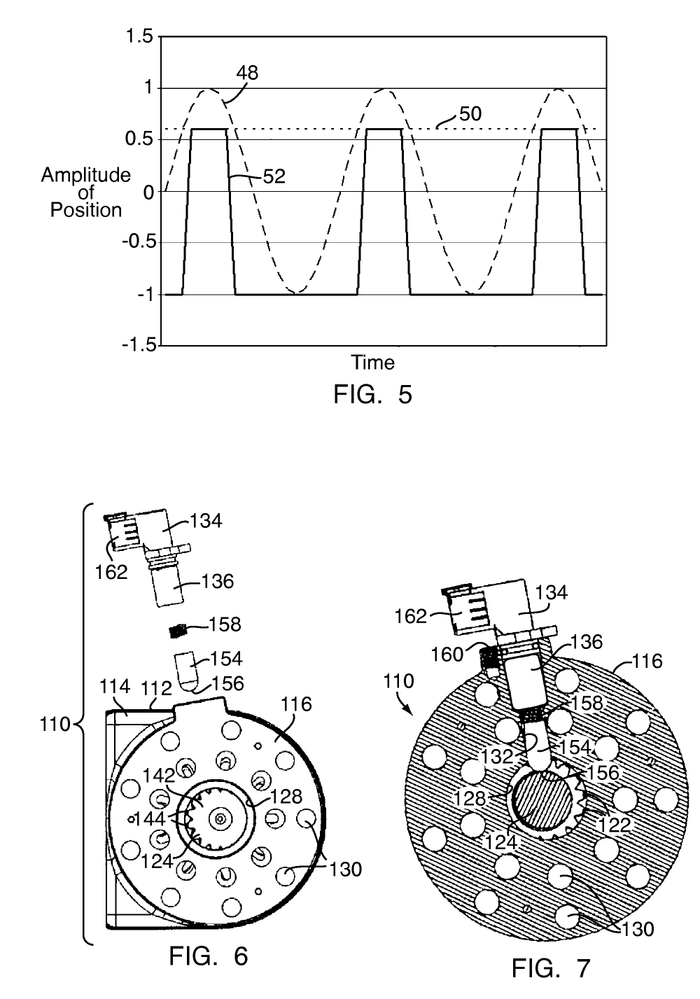

Referring to FIG. 5, as the cardan shaft 24 orbits around the disk center axis 40, an amplitude of position 48 of the cardan shaft 24 with respect to the rotation sensor 34 follows a sine curve due to the orbital movement of the second end 42 of the cardan shaft 24. The amplitude of position 48 is at a maximum of positive one (+1) when the cardan shaft 24 is closest to the rotation sensor 34 and at a minimum of negative one (−1) when the cardan shaft 24 is farthest from the rotation sensor 34. The rotation sensor 34 may be configured with a defined amplitude 50 to control switching between the ON and OFF signals of the rotation sensor 34. When the amplitude of position 48 of the cardan shaft 24 is greater than the defined amplitude 50, the rotation sensor 34 will generate and ON signal and when the amplitude of position 48 of the cardan shaft 24 is less than the defined amplitude 50, the rotation sensor 34 will be OFF and not generate a signal. Thus, as the cardan shaft 24 orbits over time, the rotation sensor 34 will generate a position curve 52, where all values above the defined amplitude 50, indicated by a dotted line in FIG. 5, will be considered as logical 1 (one) or ON and all other values as logical 0 (zero) or OFF. Thus, the rotation sensor 34 detects the cardan shaft 24 each time the cardan shaft 24 approaches the top position closest to the rotation sensor 34. Additionally, the defined amplitude 50 may be adjusted to configure the ON/OFF signal for the rotation sensor 34 in any hydraulic motor or pump with an orbiting cardan shaft.

Referring to FIGS. 6 and 7, an alternate embodiment of the hydraulic motor 110 is shown wherein like numerals represent like elements. Hydraulic motor 110 has an L-shaped rotation sensor 134 including a sensor probe 136. The L-shaped rotation sensor 134 is preferably fabricated from plastic. The hydraulic motor 110 has a piston 154 with a circular tip 156 that contacts the cardan shaft 124. A bore 132, shown in FIG. 7, is formed in the port plate 116 to accommodate the piston 154 and the rotation sensor 134. A spring 158 is disposed within the bore 132 between the piston 154 and the sensor probe 136 of the rotation sensor 134 to ensure physical contact between the piston 154 and the cardan shaft 124. The L-shaped rotation sensor 134 is mounted in the bore 132 and fixed to the port plate 116 by a bolt (not shown) in a threaded bore 160. The port plate 116 may also include bores 130 for hydraulic oil passage.

As the cardan shaft 124 rotates in orbital motion, as discussed above, the piston 154 reciprocates in bore 132, shown in FIG. 7. The sensor probe 136 of the rotation sensor 134 detects the movement of the piston 154, which corresponds to the motion of the cardan shaft 124. The amplitude of reciprocal motion of the piston 154 follows a sine curve similar to that shown in FIG. 5. Thus, the rotation sensor 134 generates its ON/OFF signal through the detection of the piston 154 in the same manner discussed above in connection with FIG. 5. In addition to ensuring contact between the piston 154 and the cardan shaft 124, the spring will need a high fatigue limit because it will experience approximately fifty (50) compression cycles for every revolution of the motor output shaft.

An advantage of the present invention is that the sensor probe 36, 136 receives signals directly from the orbiting cardan shaft 24, 124, eliminating the need for a gear wheel having teeth to generate impulses to be read by a sensor probe fixed to the housing. Thus, the present invention provides a simple design with fewer components when compared to the prior art, resulting in a less expensive design. Additionally, the gear wheel and sensor configuration for detecting rotational speed in prior art motor assemblies is largely dependent upon available internal housing space to accommodate the gear wheel and sensor and the available external housing space to accommodate the sensor's plug element 162, seen in FIGS. 6 and 7. Therefore, the prior art configuration will vary with different housing shapes, housing sizes, and internal components. The present invention overcomes the deficiencies of the prior art by eliminating the gear wheel, which allows the sensor of the present invention to advantageously be applied to almost any hydraulic motor or hydraulic pump. Thus, the present invention is ideal for an application in which the output shaft/ cardan shaft is inserted into a gearbox and/or mechanism.

A further advantage of the present invention is that it provides a high resolution signal because the sensor probe 36, 136 is taking information off of the cardan shaft 24, 124. As discussed above, the cardan shaft 24, 124 is rotating at a greater speed than the motor output shaft (not shown). Thus, the valve cardan shaft 24, 124 will orbit about disk center axis 40 approximately forty-two to forty-eight (42-48) times per motor output shaft rotation. The rotation sensor 34, 134 will, in turn, generate forty-two to forty-eight ON signals for every rotation of the motor output shaft (not shown), allowing for frequent motor speed sampling, which will provide for a high resolution signal. Additionally, the present invention will not have the same interference with the magnetic field as typical sensor systems because the sensor is located clear of the hydraulic housing structure.

Another advantage of the present invention is that it provides easier access for mounting tools since the sensor is not near to the mounting flange.

One further advantage is that the rotation speed sensor can be combined with a temperature sensor, resulting in a single built-in part for both measurements. Hall-effect sensors suitable for both speed sensing and temperature sensing are manufactured by Honeywell International Inc. of 101 Columbia Road, Morristown, N.J.

Since certain changes may be made in the above-described hydraulic motor, without departing from the spirit and scope of the invention herein involved, it is intended that all of the subject matter of the above description or shown in the accompanying drawings shall be interpreted merely as examples illustrating the inventive concept herein and shall not be construed as limiting the invention. For example, those skilled in the art will recognize that the hydraulic motor 10, 110 can be operated as either a hydraulic pump or a hydraulic motor. However, for simplicity the invention has been described throughout this application as a hydraulic motor.

What is claimed is:

1. A hydraulic motor having an orbiting rotating cardan shaft mounted in a housing with a port plate and an end cover, the hydraulic motor comprising:
a rotation speed sensor fixed to the port plate comprising a sensor probe associated with the orbiting rotating cardan shaft and obtaining a signal directly from the cardan shaft.

2. The hydraulic motor according to claim 1, wherein the rotation speed sensor is an on/off sensor.

3. The hydraulic motor according to claim 1, wherein the rotation speed sensor includes a sealing ring preventing leaking of hydraulic oil.

4. The hydraulic motor according to claim 1, wherein the sensor probe is in a form of a Hall probe.

5. The hydraulic motor according to claim 1, wherein the sensor probe is in a form of a giant magneto resistive sensor probe.

6. The hydraulic motor according to claim 1, wherein the sensor probe is in a form of an anisotropic magneto resistive sensor probe.

7. The hydraulic motor according to claim 1, wherein the sensor probe is in a form of an inductive sensor probe.

8. The hydraulic motor according to claim 1, wherein the cardan shaft is fabricated from magnetic material.

9. The hydraulic motor according to claim 1, wherein the rotation speed sensor is combined with a temperature sensor.

10. A hydraulic motor comprising:
a housing with a port plate and an end cover;
an orbiting rotating cardan shaft, which is mounted in the housing; and
a rotation speed sensor attached to the port plate and including a sensor probe associated with the orbiting rotating cardan shaft;
wherein the sensor probe obtains a signal from a piston moved by the cardan shaft.

11. The hydraulic motor according to claim 10 additionally including a biasing member ensuring that the piston is always in contact with the cardan shaft.

12. The hydraulic motor according to claim 11, wherein the biasing member is a spring.

13. The hydraulic motor according to claim 10, wherein the sensor probe is in a form of a Hall probe.

14. The hydraulic motor according to claim 10, wherein the sensor probe is in a form of a giant magneto resistive sensor probe.

15. The hydraulic motor according to claim 10, wherein the sensor probe is in a form of a anisotropic magneto resistive sensor probe.

16. The hydraulic motor according to claim 10, wherein the sensor probe is in a form of an inductive sensor probe.

17. The hydraulic motor according to claim 10, wherein the cardan shaft is made of magnetic material.

18. The hydraulic motor according to claim 10, wherein the speed sensor is an on/off sensor.

19. The hydraulic motor according to claim 10, wherein the rotation speed sensor includes a sealing ring preventing leaking of hydraulic oil.

20. A hydraulic motor comprising:
a housing with a port plate and an end cover;
an orbiting rotating cardan shaft mounted in the housing; and
a rotation speed sensor attached to the port plate and including a sensor probe associated with the orbiting rotating cardan shaft;
wherein the sensor probe receives a signal directly from the orbiting rotating cardan shaft.
